(19) United States
(12) Patent Application Publication
(10) Pub. No.: US 2015/0346474 A1
(43) Pub. Date: Dec. 3, 2015

(54) ILLUMINATION APPARATUS, MICROSCOPE APPARATUS EQUIPPED WITH SAME, AND MICROSCOPY OBSERVATION METHOD

(71) Applicant: OLYMPUS CORPORATION, Tokyo (JP)

(72) Inventor: Yoshihito IGUCHI, Tokyo (JP)

(73) Assignee: OLYMPUS CORPORATION, Tokyo (JP)

(21) Appl. No.: 14/727,337

(22) Filed: Jun. 1, 2015

(30) Foreign Application Priority Data
Jun. 2, 2014 (JP) 2014-114227
Nov. 21, 2014 (JP) 2014-236946

(51) Int. Cl. G02B 21/00

(52) U.S. Cl. CPC G02B 21/0076

(57) ABSTRACT

An illumination apparatus used for fluorescence observation of a sample containing a fluorescent material by a microscope apparatus, comprising an excitation light emission unit that emits excitation light for exciting the fluorescent material contained in the sample. The excitation light emission unit illuminates at least a bleaching reduction illumination region around an observed region in which the sample is present.

### CROSS-REFERENCE TO RELATED APPLICATION

The present application is based upon and claims the benefit of priority from the prior Japanese Patent Application No. 2014-114227 filed on Jun. 2, 2014 and No. 2014-236946 filed on Nov. 21, 2014; the entire contents of which are incorporated herein by reference.

### BACKGROUND OF THE INVENTION

1. Field of the Invention

The present invention relates to an illumination apparatus, a microscope apparatus equipped with the same, and a microscopy observation method.

2. Description of the Related Art

Microscopy observation using a fluorescence microscope is well known. In fluorescence observation, a sample marked with a fluorescent dye or fluorescent protein is irradiated with excitation light, and the sample is observed using fluorescent signals emitted from the sample.

Irradiation with excitation light invites a chemical change of the fluorescent dye or fluorescent protein caused by active oxygen generated by the excitation light. Consequently, as the fluorescence observation continues to be performed, the emission of fluorescent light from the sample gradually decreases. This phenomenon is called bleaching (see, for example, Japanese Patent Application Laid-Open No. 2005-316036).

The intensity of fluorescent light relative to the irradiation energy of the excitation light can be approximated by an exponential function (y=Aexp(Bx)+C) (Loling Sont et al., 1995). The rate of progress of bleaching is determined by the attenuation factor (bleaching factor) B.

### SUMMARY OF THE INVENTION

According to a first aspect of the present invention, there is provided an illumination apparatus used for fluorescence observation of a sample containing a fluorescent material by a microscope apparatus, comprising an excitation light emission unit that emits excitation light for exciting the fluorescent material contained in the sample, wherein the excitation light emission unit illuminates at least a bleaching reduction illumination region around an observed region in which the sample is present.

According to a second aspect of the present invention, there is provided a microscope apparatus for fluorescence observation of a sample, comprising a stage by which a sample is held, and at least one of the above-described illumination apparatus that emits excitation light with which the sample is illuminated and an objective arranged to be opposed to the sample.

According to another aspect of the present invention, there is provided a microscopy observation method for fluorescence observation of a sample including an object to be observed containing a fluorescent material using a microscope apparatus, comprising an excitation light emission step of emitting excitation light for exciting the fluorescent material contained in the sample, and an oxygen concentration reduction step of reducing the oxygen concentration at least in an observed region in which the sample is present.

### BRIEF DESCRIPTION OF THE DRAWINGS

FIG. 1 is a diagram showing configuration of an illumination apparatus and an observation optical system according to a first embodiment;

FIG. 2 is a diagram showing the configuration of an illumination apparatus and an observation optical system according to a second embodiment;

FIG. 3 is a diagram showing the configuration of an illumination apparatus and an observation optical system according to a third embodiment;

FIG. 4 is a diagram showing the configuration of an illumination apparatus and an observation optical system according to a fourth embodiment;

FIG. 5 is a diagram showing the configuration of an illumination apparatus and an observation optical system according to a fifth embodiment;

FIG. 6 is a diagram showing the configuration of an illumination apparatus and an observation optical system according to a sixth embodiment;

FIG. 7 is a diagram showing the configuration of an illumination apparatus and an observation optical system according to a seventh embodiment;

FIG. 8 is a diagram showing the configuration of an illumination apparatus and an observation optical system according to a eighth embodiment;

FIG. 9 is a diagram showing the configuration of an illumination apparatus and an observation optical system according to a ninth embodiment;

FIG. 10 is a diagram showing an arrangement of a combination of epi-illumination and trans-illumination with which a bleaching reduction illumination region is illuminated with light having a wavelength different from light for observed region;

FIG. 11 is a diagram showing an arrangement of epi-illumination with which a bleaching reduction illumination region is illuminated with light having a wavelength different from light for observed region;

FIG. 12 is a diagram showing an arrangement of trans-illumination with which a bleaching reduction illumination region is illuminated with light having a wavelength different from light for observed region;

FIGS. 13A, 13B, 13C, 13D, 13E, 13F, and 13G are diagrams illustrating bleaching reduction illumination regions;

FIGS. 14A and 14B are diagrams illustrating the observed region and the bleaching reduction illumination region;

FIGS. 15A, 15B, and 15C are diagrams showing optical members seen from the direction along the optical axis;

FIGS. 16A and 16b are flow charts of a microscopy observation method according to a tenth embodiment;

FIGS. 17A and 17B are flowcharts of an oxygen consumption step;

FIGS. 18A, 18B, and 18C are flow charts of a microscopy observation method according to a eleventh embodiment;

FIG. 19 is a flow chart of a microscopy observation method according to a twelfth embodiment;

FIG. 20 is a diagram showing the configuration of an apparatus used to carry out the microscopy observation method according to the tenth embodiment;

FIGS. 21A and 21B are diagrams showing bleaching reduction illumination regions by a sample;

FIG. 22A is a diagram showing a bleaching reduction illumination region around a sample;

FIG. 22B is a diagram showing a portion around a sample in an apparatus with which a microscopy observation method according to the eleventh embodiment is carried out;

FIG. 23A is a diagram showing a physical wall surrounding a sample;

FIG. 23B is a diagram showing a case in which an oil layer is formed in such a way as to cover a sample; and

FIG. 24 is a diagram showing an apparatus with which the microscopy observation method according to the twelfth embodiment is carried out.

### DETAILED DESCRIPTION OF THE INVENTION

Prior to describing embodiments, a principle of decrease of fluorescent light will be described first. This principle was discovered by the inventor of the present invention through strenuous studies. A major cause of bleaching is a chemical change of a sample caused by active oxygen. When a sample is illuminated with excitation light, oxygen in the portion of the sample illuminated with excitation light changes into active oxygen, which oxidizes materials around. Thus, bleaching of fluorescent material progresses slowly. Moreover, since the amount of oxygen in the irradiated portion decreases, oxygen enters the portion irradiated with the excitation light by diffusion from the portion around the irradiated portion that is not illuminated with the excitation light. Oxygen thus entering also changes into active oxygen by irradiation with the excitation light and combines with fluorescent materials and other materials to cause further bleaching. It is considered that bleaching is promoted in this way.

In view of the above, excitation light having a relatively high intensity is applied in such a way as to cover the outer periphery of an observed region or to surround the observed region, thereby activating oxygen existing in the neighborhood of the periphery of the observed region in which the sample is present. Active oxygen combines with fluorescent materials and other materials in the region outside the observed region. Thus, oxygen about to enter the observed region is consumed in the region outside the observed region. Consequently, the entry of oxygen into the region in which the observed sample is present is reduced, so that the generation of active oxygen in the observed region can be reduced.

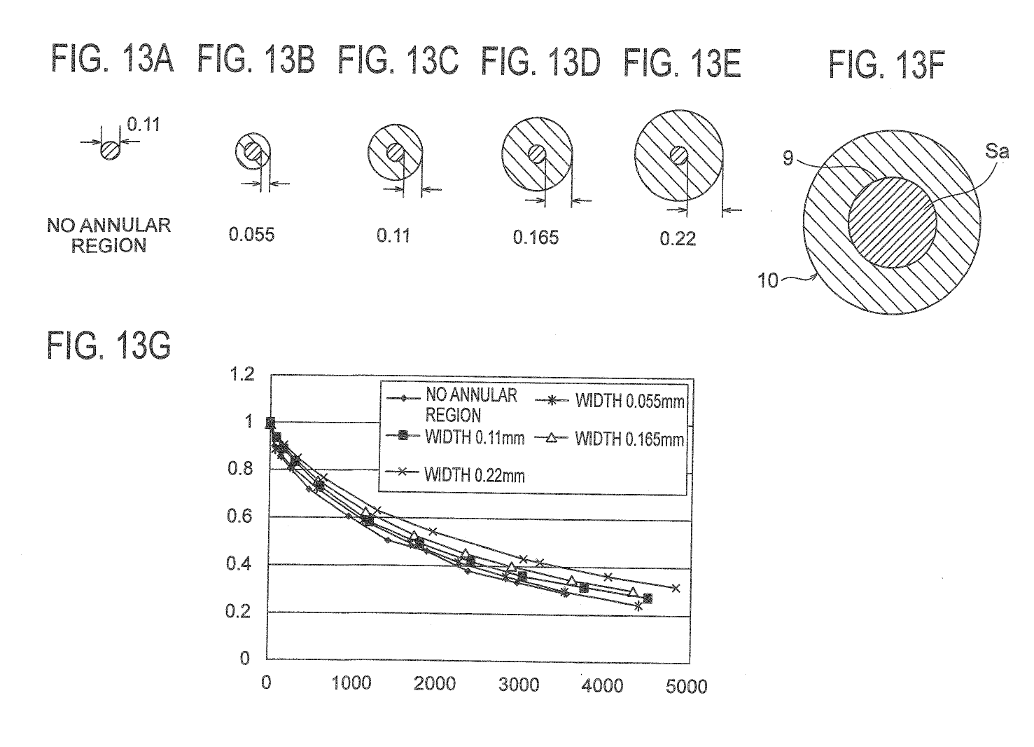

FIGS. 13A, 13B, 13C, 13D, 13E, 13F, and 13G are diagrams illustrating the above described concept.

In FIG. 13F, a sample Sa exists in an observed region 9 in which the sample is observed. A bleaching reduction illumination region 10 exists around the outer periphery of observed region 9. For example, the sample Sa is present in the observed region 9. The bleaching reduction illumination region 10 is illuminated with excitation light, for example, at a higher irradiance as compared to the observed region 9. This will be described in more detail in the description of the embodiments.

FIG. 13A shows a case in which only the observed region 9 (having a width of 0.11 mm) is present. FIGS. 13B, 13C, 13D, and 13E show cases in which an annular bleaching reduction illumination region is present around the observation region 9. The width of the bleaching reduction illumination region is increased from FIG. 13B to FIG. 13E. Specifically, the width of the bleaching reduction illumination region 10 is 0.055 mm, 0.11 mm, 0.165 mm, and 0.22 mm in FIGS. 13B, 13C, 13D, and 13E respectively.

In the graph in FIG. 13G, the horizontal axis represents the product of the excitation light intensity (W) and the irradiation time (second) divided by the illumination area (cm²), and the vertical axis represents the brightness (normalized to one) of the observed image in the observed region 9.

As will be easily understood from FIG. 13G, even in the case, for example, where the excitation light intensity (W) and the irradiation time (second) are fixed, the larger the area of the annular bleaching reduction illumination region 10 is, the brighter the observed image of the observed region 9 is. In other words, the larger the area of the annular bleaching reduction illumination region 10 is, the more the bleaching in the observed region 9 can be reduced.

(Observed View Field Range)

In a microscope apparatus composed of an illumination apparatus according to one of embodiments that will be described later and an observation optical system, one of the following two cases applies, depending on its configuration.

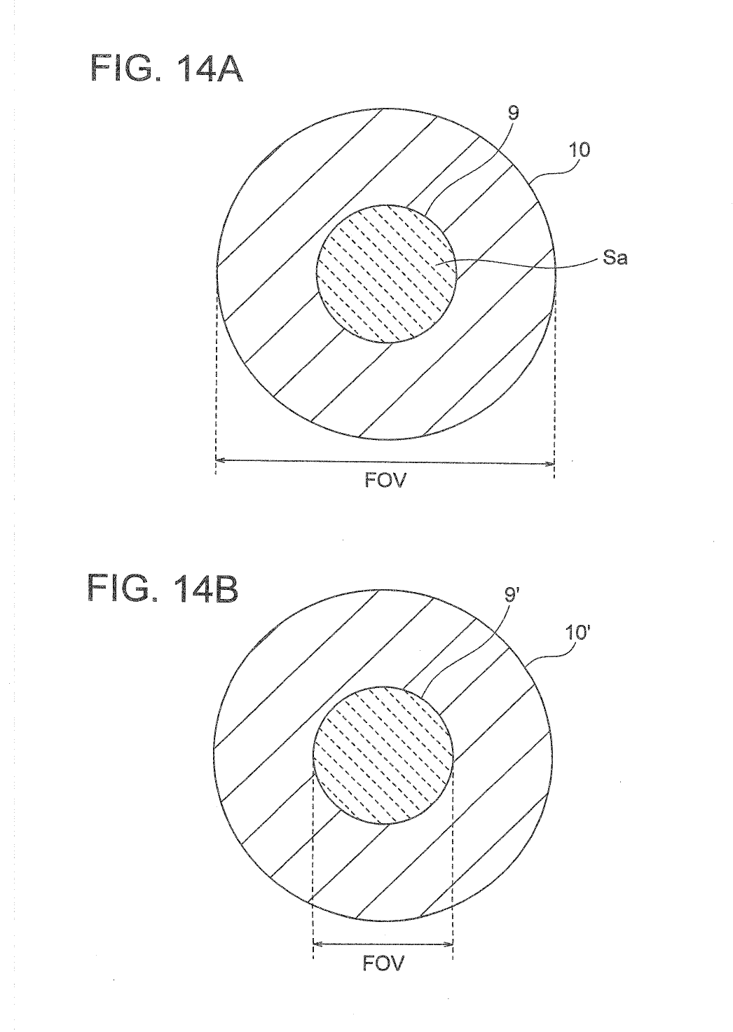

FIGS. 14A and 14B show an observed region 9 and a bleaching reduction illumination region 10.

FIG. 14 shows a case in which the observed region 9 and the bleaching reduction illumination region 10 are both seen in the actual field of view of the objective of the microscope apparatus.

FIG. 14B shows a case in which an observed region 9′ in which a sample is observed is located in the field of view of the objective and a bleaching reduction illumination region 10′ around the outer periphery of the observed region 9′ is located outside the actual field of view of the objective.

In the following, embodiments of the illumination apparatus and the microscope apparatus equipped with the same according to the present invention will be described specifically with reference to the drawings. It should be understood that the embodiments are not intended to limit the present invention.

### First Embodiment

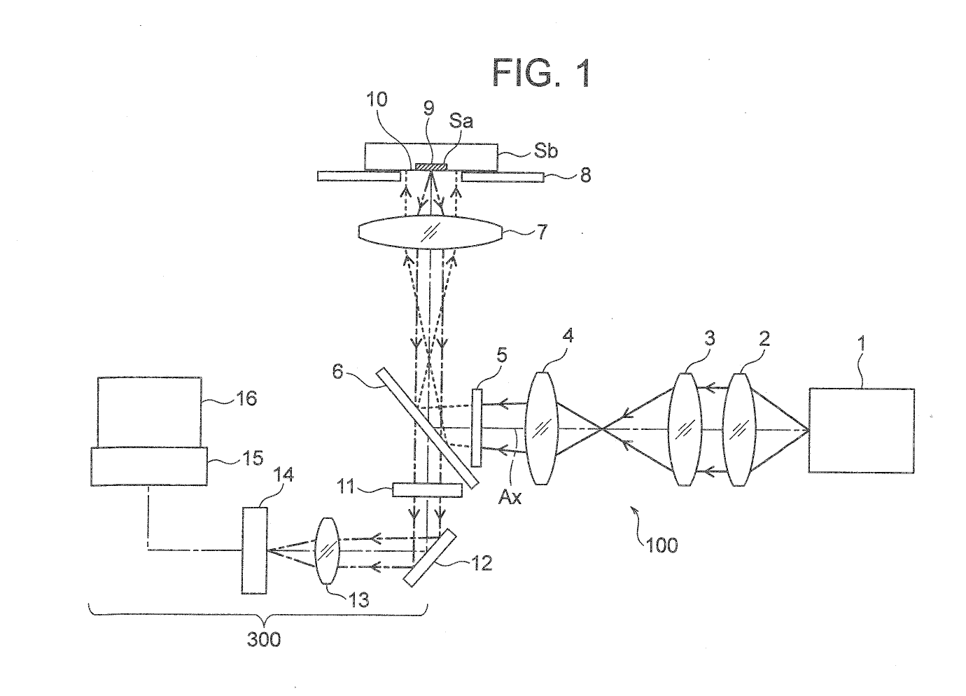

FIG. 1 shows the configuration of an illumination apparatus 100 and an observation optical system 300 according to a first embodiment. The illumination apparatus 100 and the observation optical system 300 constitute a microscope apparatus.

Firstly, the illumination apparatus 100 will be described. The illumination apparatus 100 has an illumination light source 1 constituting an excitation light emission unit, which emits light including excitation light that excites an optical material contained in a sample Sa. Light emitted from the illumination light source 1 passes through lenses 2, 3, and 4 and is incident on an excitation filter 5. The excitation filter 5 selectively transmits only light in a specific wavelength range and blocks light of the other wavelength ranges. The transmitted light serves as excitation light.

The excitation filter 5 is what is called a band-pass filter. The excitation wavelength varies depending on the fluorescent material. Therefore, in fluorescence observation, an excitation filter 5 suitable for the characteristics of the fluorescent material used is employed in combination with it.

The light transmitted through the excitation filter 5 is incident on a dichroic mirror 6. The dichroic mirror 6 is arranged on the optical axis AX at an angle of 45 degrees. The dichroic mirror is a mirror having a long-pass function. In fluorescence, the wavelength of the fluorescent light is longer than the wavelength of the excitation light. Therefore, the spectral transmission characteristics of the dichroic mirror 6 is designed to reflect or absorb the excitation light having a short wavelength and to transmit the fluorescent light having a long wavelength.

The excitation light reflected by the dichroic mirror 6 is converted into parallel light by a lens 7 (objective) to illuminate a specimen Sb. The lens 7 is an objective. The specimen Sb is placed on a stage 8. A fluorescent signal is emitted as fluorescent light from fluorescent dye with which the sample Sa is marked in the observed region 9 of the specimen Sb in which the sample Sa exists, toward the lens 7.

The fluorescent light emitted from the sample is transmitted through the lens 7 and the dichroic mirror 6 and is incident on an absorption filter 11. The absorption filter 11 transmits the fluorescent light and cuts (i.e. reflects and/or absorbs) the light of other wavelengths.

The excitation light emission unit emits excitation light for exciting the fluorescent material contained in the sample Sa using light emitted from the illumination light source 1.

The illumination light source 1 illuminates at least the observed region 9 in which the sample Sa exists and the bleaching reduction illumination region 10 around the observed region 9.

As described above, in this embodiment, the excitation light emission unit is an epi-illumination unit, which illuminates the sample Sa with light emitted from the illumination light source 1 through the lens 7.

Thus, the lens 7 (objective) functions both in the observation optical system and excitation light irradiation optical system. Therefore, a condenser lens is not needed.

(Observation Optical System)

Next, the observation optical system 300 will be described. The light reflected by a reflection mirror 12 arranged on the optical axis at an inclination angle of 45 degrees is incident on a lens 13. The lens 13 introduces the fluorescent light onto an imaging apparatus such as a camera. The microscope apparatus has a computer 15, which performs image processing on the fluorescent signal generated by the imaging apparatus 14. A fluorescent image of the sample Sa is displayed on a monitor 16.

In the illumination apparatus 100 according to this embodiment, in cases where a nucleus is dyed with DAPI, U-excitation (UV-excitation) is preferable. In cases where a microtubule is dyed with Alexa Fluor 488, B-excitation (blue-excitation) is preferable. In cases where a mitochondria is dyed with Mito Tracker Red, G-excitation (green-excitation) is preferable.

### Second Embodiment

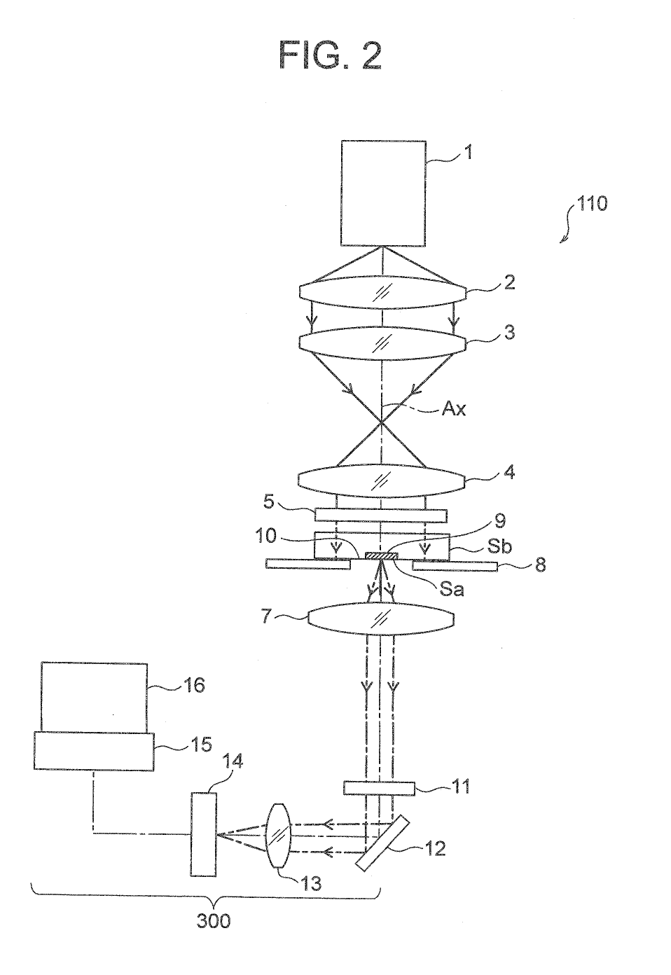

FIG. 2 shows the configuration of an illumination apparatus 110 and an observation optical system 300 according to a second embodiment.

The illumination apparatus 110 has an illumination light source 1, which constitutes an excitation light emission unit of a trans-illumination type that emits excitation light to the stage 8 from the side opposite to the lens 7.

Light emitted from the illumination light source 1 is transmitted through lenses 2, 3, and 4. Thereafter, the light is transmitted through an excitation filter 5 and illuminates the observed region 9 and the bleaching reduction illumination region 10.

Fluorescent light emitted from the sample Sa in the observed region 9 is incident on a lens 7 and transmitted through an absorption filter 11, which transmits the fluorescent light and cuts (or reflects) light of the other wavelengths. Thereafter, the fluorescent light is introduced to an observation optical system 300.

This arrangement can easily provide an illumination area larger than that in the case of epi-illumination.

### Third Embodiment

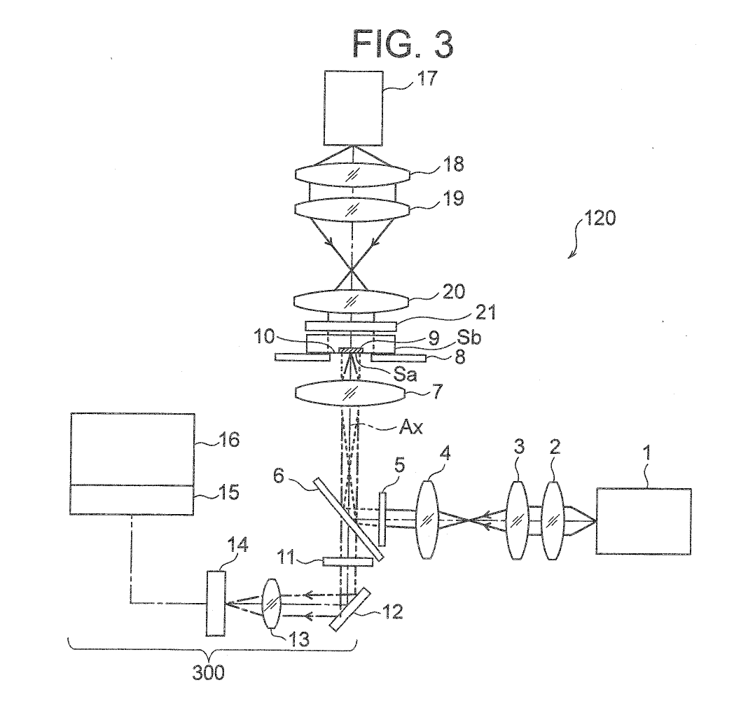

FIG. 3 shows the configuration of an illumination apparatus 120 and an observation optical system 300 according to a third embodiment. The illumination apparatus 120 of this embodiment has an excitation light emission unit as an illumination light source including a first illumination light source 1 (first excitation light emission unit) of an epi-illumination type that illuminates a sample Sa with excitation light through a lens 7 and a second illumination light source 17 (second excitation light source) of a trans-illumination type that irradiates the sample Sa with excitation light from the side opposite to the lens 7.

Specifically, light emitted from the first illumination light source 1 is transmitted through lenses 2, 3, and 4. Thereafter, the light is transmitted through an excitation filter 5 and incident on a dichroic mirror 6. The dichroic mirror 6 is arranged on the optical axis AX at an angle of 45 degrees. The excitation light reflected by the dichroic mirror 6 is converted into parallel light by a lens 7 (objective) to illuminate an observed region in which a sample Sa is present.

On the other hand, light emitted from the second illumination light source 17 (second excitation light emission unit) is transmitted through lenses 18, 19, and 20 and illuminates a bleaching reduction irradiation retion 10 around the observed region 9.

Fluorescent light generated in the sample Sa is transmitted through the lens 7 and the dichroic mirror 6 and introduced into an observation optical system 300.

The apparatus according to this embodiment having the above-described configuration is advantageous in that the irradiance of the first excitation light emitted from the first illumination light source 1 (first excitation light emission unit) and the irradiance of the second excitation light emitted from the second illumination light source 17 (second excitation light emission unit) can be set separately as desired.

Moreover, if the lower limits of the following conditions (1) and (2) are satisfied, the quantity of oxygen or active oxygen entering the observed region 9 from outside the observed region 9 is reduced, so that bleaching in the observed region 9 due to oxidation can be reduced. Therefore, satisfying the conditions (1) and (2) helps the elongation of the time allowing the observation of the sample Sa in the specimen Sb without changing the irradiance of the excitation light in the observed region 9 in fluorescence observation.

Therefore, it is preferred that the following conditions (1) and (2) be satisfied:

1.3<φexc/φobj (1), and

0.002 mm<φexc−φobj (2),

where φobj is the largest diameter of the region 9 observed by the lens 7 (objective) of the microscope apparatus on the surface of the sample Sa, and φexc is the largest diameter of the excitation light on the surface of the sample Sa emitted by the first illumination light source 1 or the second illumination light source 17 as the excitation light emission unit.

Thus, the region illuminated with the excitation light is larger than the observed region 9, and therefore, active oxygen is generated in the region around the observed region 9. Consequently, it is possible to cause active oxygen to combine with fluorescent materials and other materials in the region outside the observed region 9. This helps the reduction of bleaching in the observed region.

It is preferred that the following conditions (1-1) and (2-1) be satisfied instead of conditions (1) and (2):

2.0<φexc/φobj (1-1), and

0.004 mm<φexc—φobj (2-1).

It is more preferred that the following conditions (1-2) and (2-2) be satisfied instead of conditions (1) and (2):

2.0<φexc/φobj<20 (1-2), and

0.004 mm<φexc—φobj<2 mm (2-2).

If the values defined in conditions (1-2) and (2-2) exceed the respective upper bounds, the bleaching reduction effect is diminished.

### Fourth Embodiment

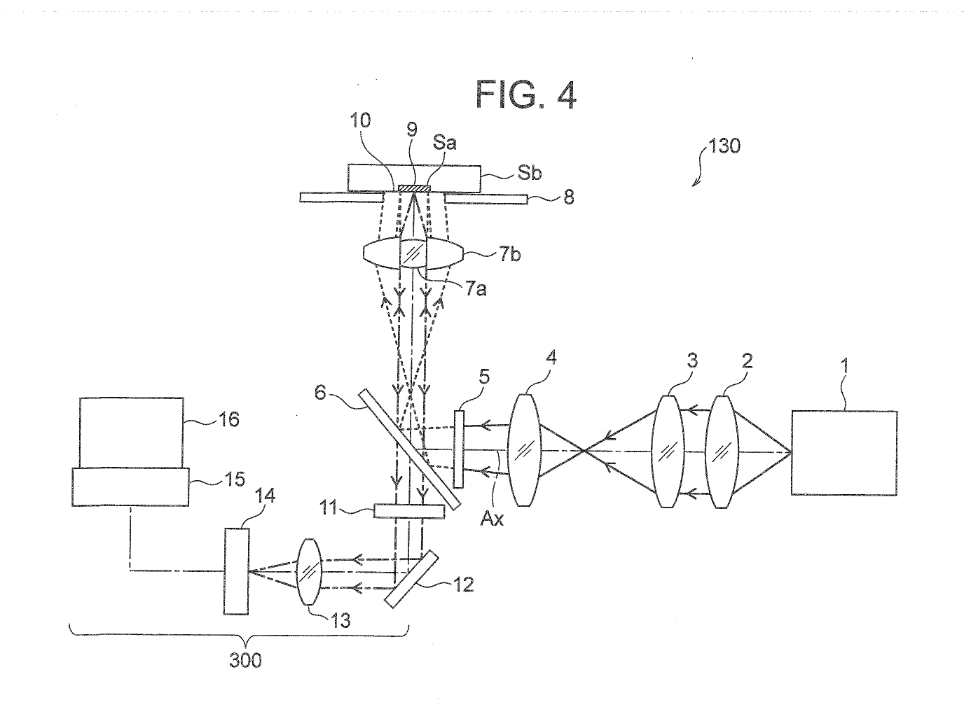

FIG. 4 shows the configuration of an illumination apparatus 130 and an observation optical system 300 according to a fourth embodiment.

The illumination apparatus 130 according to this embodiment is of an epi-illumination type. Light emitted from the illumination light source 1 passes through lenses 2, 3, and 4 and then is introduced to a lens 7a (objective) through an excitation filter 5 and a dichroic mirror 6. Around the lens 7a, there is provided a lens 7b, which surrounds the lens 7a.

The light transmitted through the lens 7a illuminates an observed region 9. The light transmitted through the lens 7b illuminates a bleaching reduction illumination region 10.

Fluorescent light emitted from a sample Sa in the observed regions transmitted through the lens 7a. The light transmitted through the lens 7a is further transmitted through the dichroic mirror 6 and an absorption filter 11. The light transmitted through them is introduced to an observation optical system 300.

There may be various modifications of the epi-illumination apparatus, which include, for example, an apparatus in which the bleaching reduction illumination region 10 is illuminated through another lens provided outside the objective 7a as described in this embodiment and an apparatus in which an optical fibers are provided outside the objective 7a to illuminate the bleaching reduction illumination region 10 with light guided through the optical fiber.

### Fifth Embodiment

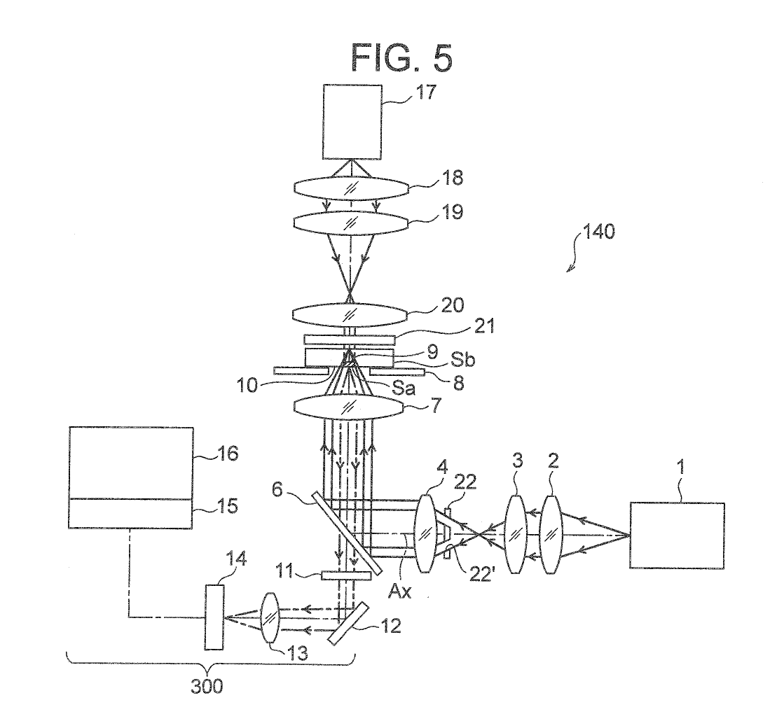

FIG. 5 shows the configuration of an illumination apparatus 140 and an observation optical system 300 according to a fifth embodiment.

In this embodiment, the area illuminated by an excitation light emission unit including an illumination light source 1 includes at least an observed region 9 in which a sample Sa is observed and a bleaching reduction illumination region 10 around the outer periphery of the observed region 9, and the irradiance of excitation light with which the bleaching reduction illumination region 10 is illuminated is different from the irradiance of excitation light with which the observed region 9 is illuminated.

In particular, the irradiance of the excitation light with which the bleaching reduction illumination region 10 is illuminated is higher than the irradiance of the excitation light with which the observed region 9 is illuminated.

As above, the region outside the observed region 9 is also illuminated with excitation light at a high irradiance, whereby active oxygen is generated more effectively in the region around the observed region 9. This is advantageous in that active oxygen combines with fluorescent materials and other materials in the region outside the observed region 9.

The apparatus according to the present invention further includes an illumination optical system by which the excitation light emitted from the excitation light emission unit and illuminating the observed region 9 is focused on the sample surface in the observed region 9. The excitation light emission unit focuses the excitation light illuminating the bleaching reduction illumination region at a position different from the sample surface with respect to the direction of the optical axis AX.

For example, light emitted from the illumination light source 1 and transmitted through lenses 2 and 3 is shaped into annular light by an optical member 22. The apparatus has a stage 8 arranged at a position conjugate with the optical member 22. Therefore, light transmitted through a lens 7 illuminates the bleaching reduction illumination region 10 or the region around the observed region 9 as beams having a hollow conical overall shape.

In this embodiment, with the above features, oxygen diffusing into the region near the observed region 9 along the optical axis AX is also changed into active oxygen, which combines with fluorescent materials and other materials in the region outside the observed region 9.

### Sixth Embodiment

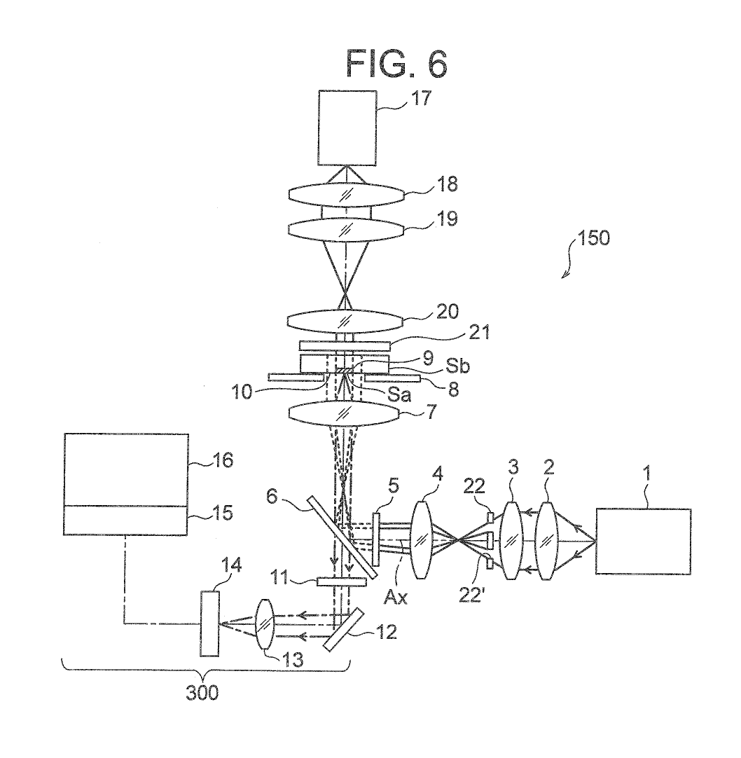

FIG. 6 shows the configuration of an illumination apparatus 150 and an observation optical system 300 according to a sixth embodiment. The illumination apparatus 150 in this embodiment has an excitation light emission unit including a first illumination light source 1 serving as a first excitation light emission unit and a second illumination light source 17 serving as a second excitation light emission unit.

The first illumination light source 1 is an epi-illumination unit that sheds excitation light on a bleaching reduction illumination region 10 through a lens 7.

The second illumination light source 17 as the second excitation light emission unit is a trans-illumination unit that sheds excitation light on a sample Sa in an observed region 9 from the side opposite to the lens 7.

The first illumination light source 1 (first excitation light emission unit) that sheds excitation light on the bleaching reduction illumination region 10 with the excitation light has an optical member 22 having a slit 22′ arranged in the optical path at the position of a field stop conjugate with the sample Sa.

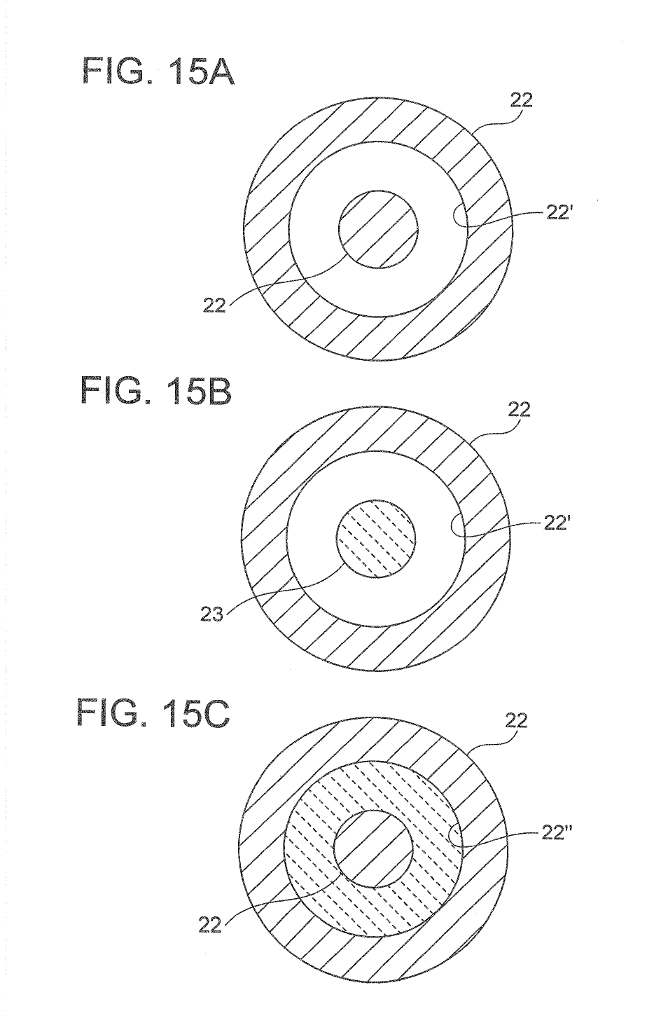

FIG. 15A shows the optical member 22 seen in the direction along the optical axis. The slit 22′ of the optical member 22 has an annular shape that is rotationally symmetrical about the optical axis.

Returning back to FIG. 6, light having passed through the slit 22′ is transmitted through a lens 4 and an excitation filter 5, and directed toward the lens 7 by a dichroic mirror 6. Thus, the light illuminates the bleaching reduction illumination region 10 through the lens 7.

Light emitted from the second illumination light source 17 (second excitation light emission unit) is transmitted through lenses 18, 19, and 20. The transmitted light is transmitted through an excitation filter 21 and illuminates the sample Sa in the observed region 9.

Fluorescent light emitted from the sample is transmitted through the lens 7, the dichroic mirror 6, and an absorption filter 11. The transmitted light is introduced to an observation optical system 300.

### Seventh Embodiment

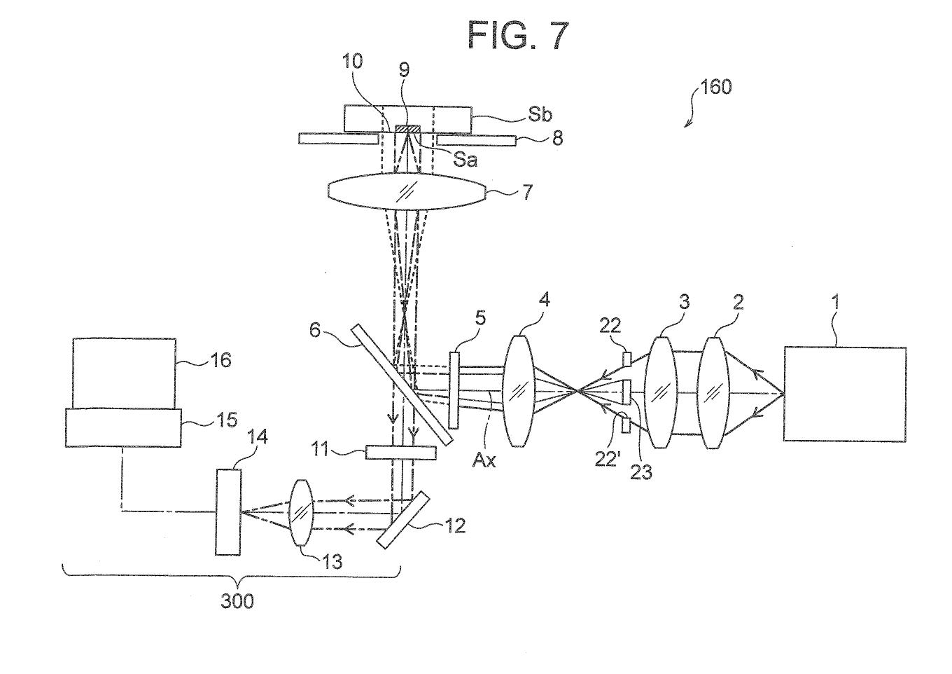

FIG. 7 is a diagram showing the configuration of an illumination apparatus 160 and an observation optical system 300 according to a seventh embodiment.

The illumination apparatus 160 according to this embodiment has an illumination light source 1 serving as an excitation light emission unit, which is an epi-illumination unit that sheds excitation light on a sample Sa through a lens 7.

In the apparatus of this embodiment, the irradiance of excitation light on an observed region 9 and the irradiance of excitation light on a bleaching reduction illumination region 10 can be set completely independently from each other.

The illumination apparatus according to this embodiment has an optical member 22 the same as the optical member 22′ in the sixth embodiment. An ND filter 23 is provided on the optical member 22 in a region closer to the optical axis than the slit 22′ of the optical member 22. The observed region is illuminated with excitation light transmitted through the ND filter 23, and the bleaching reduction illumination region 10 is illuminated with excitation light passing through the slit 22′. FIG. 15B is a diagram showing the optical member 22 seen along the direction of the optical axis. The optical member 22 has the annular slit 22′ provided in it. The ND filter 23 has a predetermined transmittance and is provided on the central portion of the optical member 22.

As above, the same illumination optical system may serve as both the illumination optical system for observation and the illumination optical system for bleaching reduction.

### Eighth Embodiment

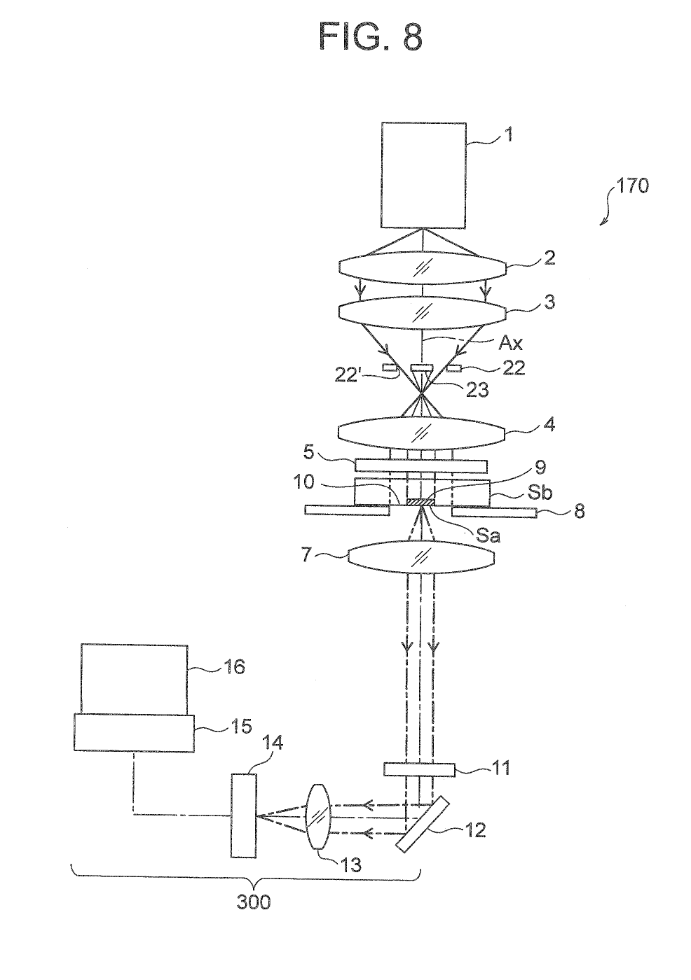

FIG. 8 is a diagram showing the configuration of an illumination apparatus 170 and an observation optical system 300 according to an eighth embodiment.

The illumination apparatus 170 according to this embodiment has an illumination light source 1 as an excitation light emission unit. The illumination light source 1 is a trans-illumination unit that sheds excitation light on a sample Sa from the side opposite to a lens 7.

The illumination apparatus 170 has an optical member 22 provided in the optical path at the position of a field stop conjugate with the sample Sa. The optical member 22 has a slit 22′ and is provided with an ND filter 23 arranged closer to the optical axis than the slit 22′. The excitation light transmitted through the ND filter 23 illuminates an observed region 9, and the excitation light passing through the slit 22′ illuminates a bleaching reduction illumination region 10.

Fluorescent light emitted from the sample Sa is transmitted through the lens 7 and an absorption filter 11 and introduced to an observation optical system.

In this embodiment also, as with the seventh embodiment, the irradiance of the light illuminating the observed region 9 is made lower than the irradiance in the region around the observed region (i.e. the irradiance in the bleaching reduction illumination region) by the ND filter 23.

Alternatively, the optical member 22 may have a hole at its center through which light illuminating the observed region 9 passes, and an ND filter is provided around the center hole. In this case, the region outside the observed region 9 is irradiated with excitation light at a low irradiance, so that active oxygen is generated in the region around the observed region 9 with reduced bleaching in the region outside the observed region 9. This is advantageous in that active oxygen can combine with fluorescent materials and other materials in the region outside the observed region 9.

### Ninth Embodiment

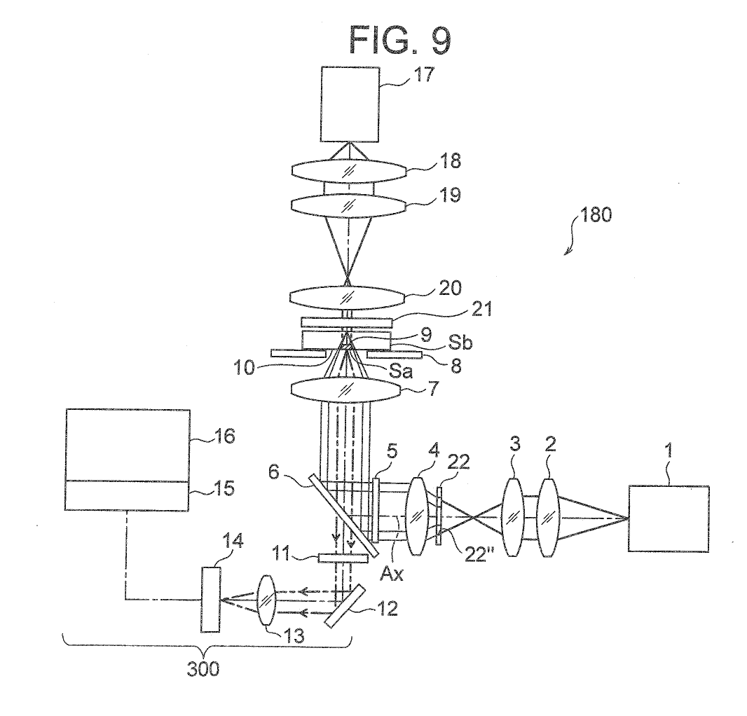

FIG. 9 is a diagram showing the configuration of an illumination apparatus 180 and an observation optical system 300 according to a ninth embodiment.

The area illuminated by an excitation light emission unit including illumination light sources 1, 17 includes at least an observed region 9 in which a sample Sa is observed and a bleaching reduction illumination region 10 around the outer periphery of the observed region 9, and the wavelength of excitation light with which the bleaching reduction illumination region 10 is illuminated is different from the wavelength of excitation light with which the observed region 9 is illuminated.

The excitation light emitted from the illumination light sources 1, 17 (excitation light emission units) and illuminating the observed region 9 is focused on the surface of the sample Sa in the observed region 9, and the excitation light illuminating the bleaching reduction illumination region is focused at a position different from the surface of the sample Sa with respect to the direction of the optical axis.

The excitation light emission unit includes the first illumination light source 1 (first excitation light emission unit) and the second illumination light source 17 (second excitation light emission unit). The first illumination light source 1 is an epi-illumination unit that sheds excitation light on the bleaching reduction illumination region 10 through a lens 7. The second illumination light source 17 is a trans-illumination unit that sheds excitation light on the sample Sa in the observed region 9 from the side opposite to the lens 7.

The first illumination light source 1 that illuminates the bleaching reduction illumination region 10 with excitation light is provided with an optical member 22 having a slit 22″ arranged in the optical path at the position of a field stop conjugate with the sample Sa.

The slit 22″ of the optical member 22 has an annular shape rotationally symmetrical about the optical axis. As shown in FIG. 15C, the slit 22″ is a wavelength selection element.

As above the region outside the observed region 9 is illuminated with excitation light having a wavelength different from excitation light with which the observed region 9 is irradiated. This can reduce bleaching in the observed object inside the observed region 9.

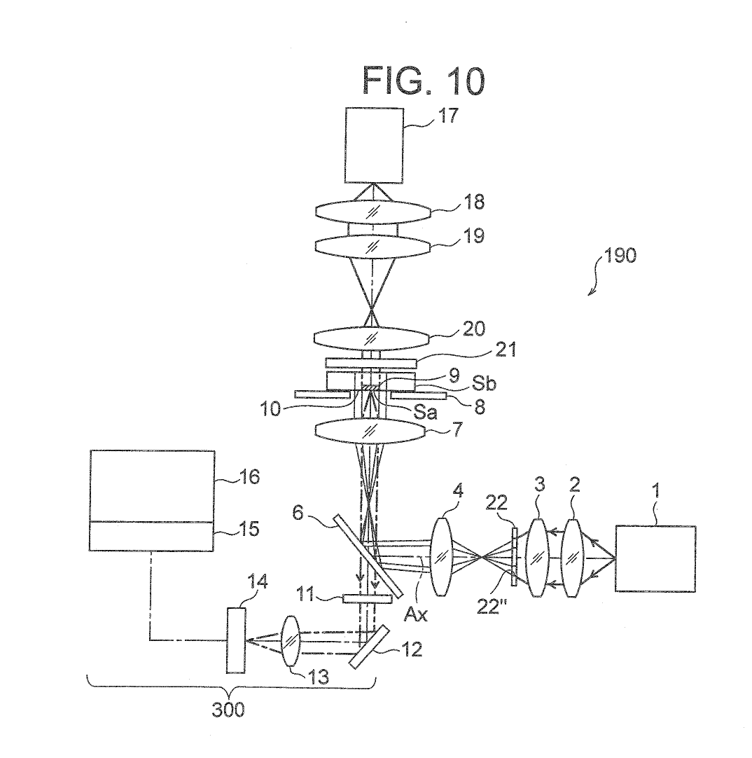

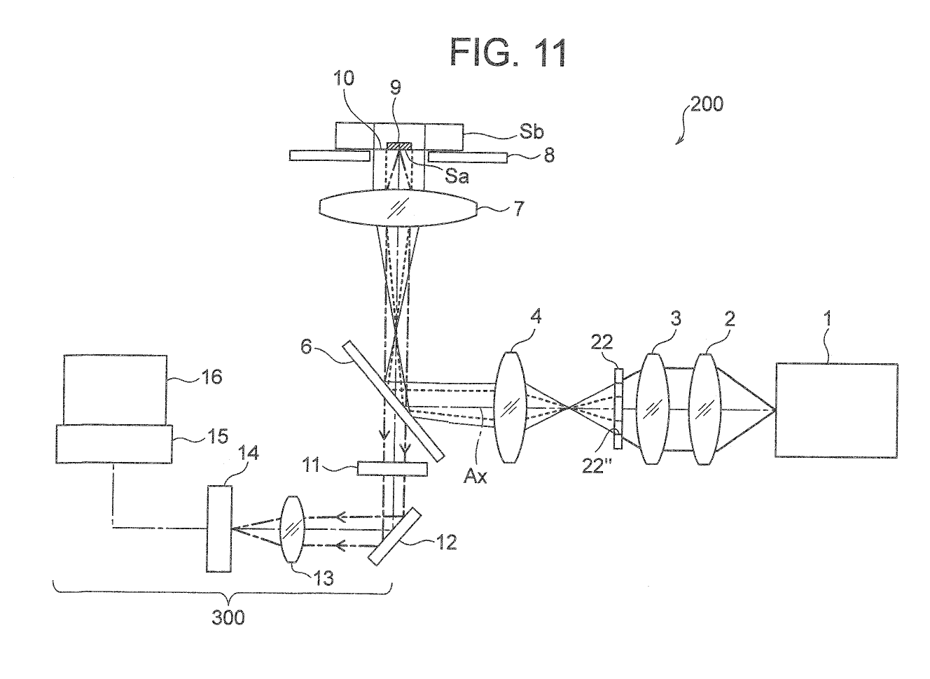

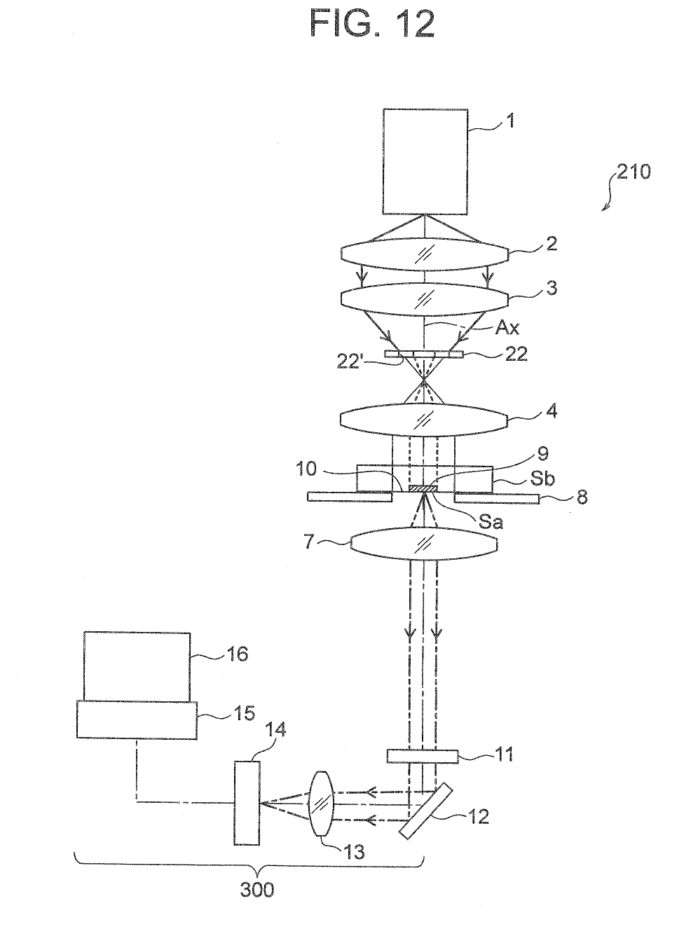

As with the mode of illumination with different irradiances, the mode of illumination with different wavelengths may be implemented in various manner, for example, using a combination of trans-illumination and epi-illumination shown in FIG. 10, epi-illumination shown in FIG. 11, and trans-illumination shown in FIG. 12.

It is preferred that the wavelength of excitation light used to reduce bleaching be shorter than a specific wavelength.

For example, in a case where the specific wavelength of excitation light used to excite the sample Sa is the wavelength of red (R) light, it is preferred that the light used to reduce bleaching be ultraviolet (UV) light, blue (B) light, and green (G) light, where the shorter the wavelength (i.e. the former among the above three kinds of light) is, the more preferable it is. In particular, it is preferred that the wavelength be equal to shorter than 400 nm.

### Tenth Embodiment

A microcopy observation method according to a tenth embodiment will be described in the following. All the microscopy observation methods described in the following are microscopy observation methods for fluorescence observation of a sample including an object to be observed that contains fluorescent material using a microscope apparatus.

In the context of the present invention, the term “sample” refers to an object that includes at least an object to be observed. The term “observed region (or area)” refers to a region (or area) in which the sample is illuminated with observation light and fluorescence observation of the sample is performed. The term “specimen” refers to an overall structure such as a container or a glass plate containing the sample.

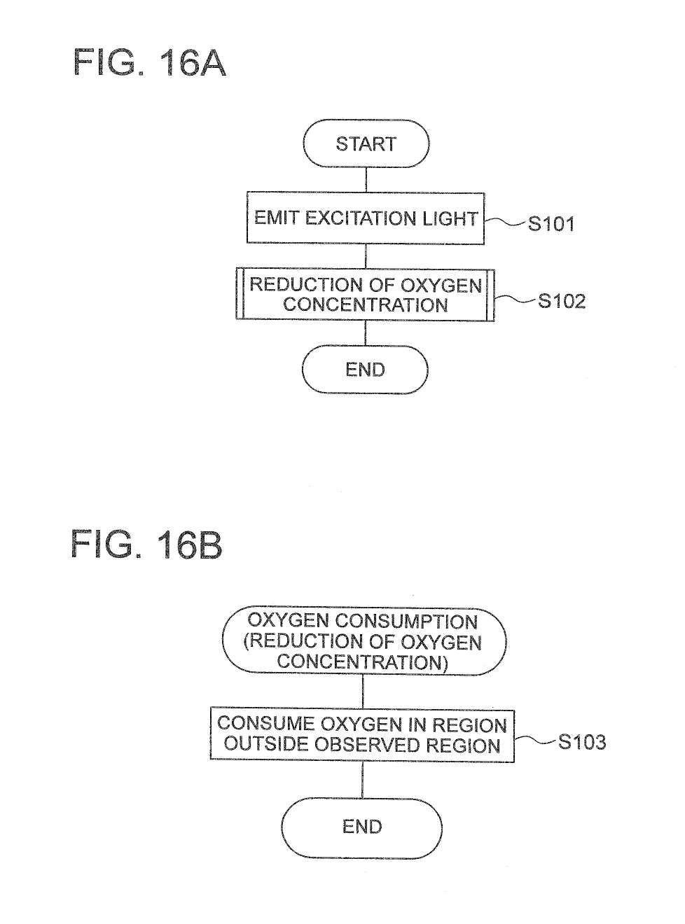

FIG. 16A is a flow chart of the procedure carried out in this embodiment.

In an excitation light emission step S101, excitation light for exciting the fluorescent material contained in the sample Sa is emitted.

In an oxygen concentration reduction step S102, the concentration of oxygen at least in the observed region in which the sample Sa is present is reduced.

As shown in FIG. 16B, in the oxygen concentration reduction step includes an oxygen consumption step S103, in which oxygen is consumed in a region outside the observed region.

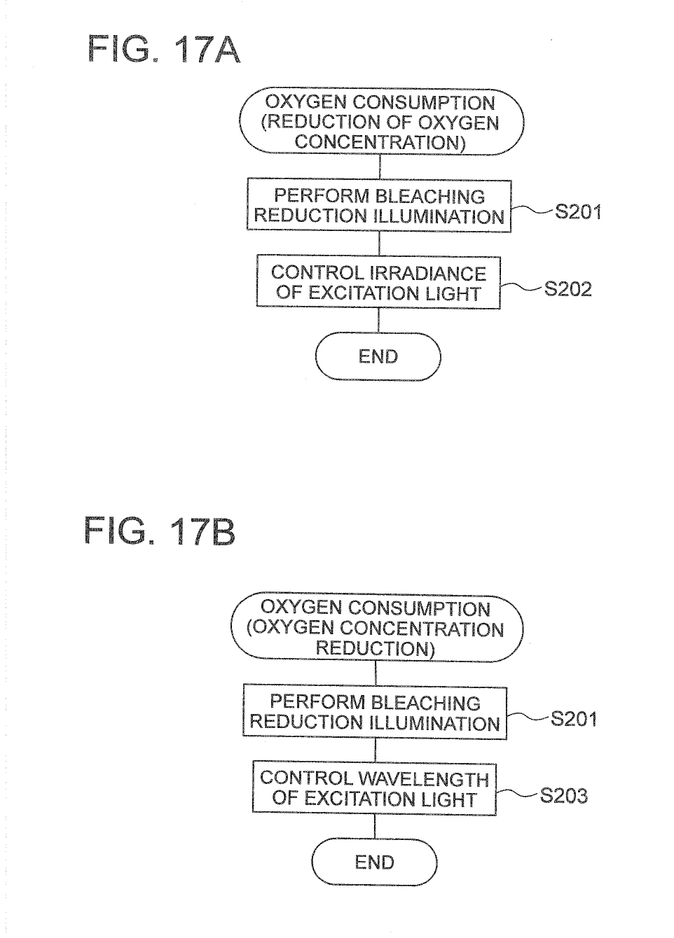

Specifically, as shown in FIG. 17A, the oxygen consumption step includes the step of performing bleaching reduction illumination and the step of controlling the irradiance of the excitation light.

In step S201, at least a bleaching reduction illumination region around the observed region in which the sample Sa is present is illuminated. In step S202, the irradiance of the excitation light used in the bleaching reduction illumination step is controlled.

In the bleaching reduction illumination step, it is preferred that the irradiance of the light with which the bleaching reduction illumination region is illuminated be higher than the irradiance of the light with which the observed region is illuminated.

Alternatively, as shown in FIG. 17B, the oxygen consumption step may include the step of performing bleaching reduction illumination and the step of controlling the wavelength of excitation light.

In step S201, at least the bleaching reduction illumination region around the observed region in which the sample Sa is present is illuminated. In step S203, the wavelength of the excitation light used in the bleaching reduction illumination step is controlled.

In the bleaching reduction illumination step, it is preferred that the bleaching reduction illumination region be illuminated with excitation light having a wavelength shorter than a specific wavelength.

For example, in a case where the specific wavelength of excitation light used to excite the sample Sa is the wavelength of red (R) light, it is preferred that the light used to reduce bleaching be ultraviolet (UV) light, blue (B) light, and green (G) light, where the shorter the wavelength (i.e. the former among the above three kind of light) is, the more preferable it is. In particular, it is preferred that the wavelength be equal to shorter than 400 nm.

In the following, the configuration of an apparatus used to implement the microscopy observation method according to this embodiment will be described. In the following description, the components the same as those in the above-described first embodiment are denoted by the same reference signs and will not be described redundantly.

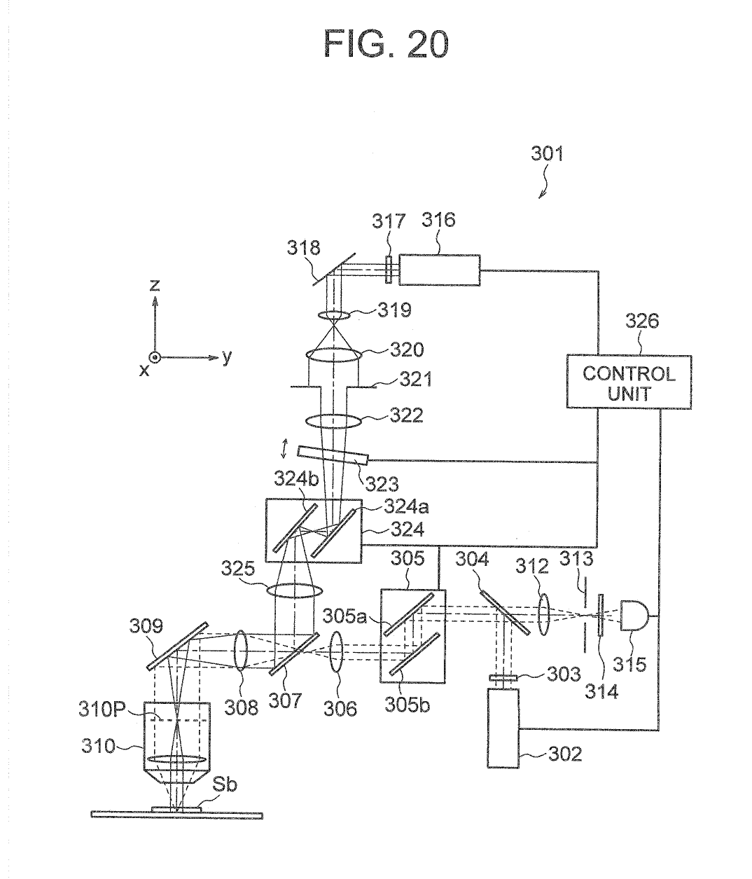

FIG. 20 is a diagram showing the configuration of a laser microscope with which the method of this embodiment is implemented. The laser microscope 301 shown in FIG. 20 includes a scan unit 305 for observation and a scan unit 324 for stimulus, which operate independently from each other, to constitute what is called a twin scan system, which can image a specimen Sb while giving stimulus light to a desired portion of the specimen Sb to allow observation of the response to the stimulus light.

The laser microscope 301 also includes a plane parallel plate 323 provided in the path of the stimulus light in addition to the scanning unit 324. The plane parallel plate serves as a shift unit for shifting the stimulus light in a direction perpendicular to the optical axis. The laser microscope 301 can control the irradiation position and the irradiation angle of the stimulus light on the specimen Sb independently from each other by controlling the plate parallel plate 323 and the scanning unit 324 by a control unit 326.

Now, the configuration of the laser microscope 301 will be specifically described. The laser microscope 301 includes an observation unit including an excitation unit for observation, a stimulus light unit, and the control unit 326.

The observation unit includes a laser light source 302, a shutter 303, a dichroic mirror 304, the scan unit 305, a pupil projection lens 306, a dichroic mirror 307, an imaging lens 308, a mirror 309, an objective 310, a confocal lens 312, a confocal stop 313, a barrier filter 314, and a photodetector 315. The laser light source 302 emits excitation light (laser light) for exciting the specimen Sb. The dichroic mirror 304 reflects the excitation light and transmits the fluorescent light. The scan unit 305 scans the specimen Sb by moving the focus position of the excitation light on the specimen Sb. The pupil projection lens 306 projects the pupil of an objective 310 onto the scan unit 305 in cooperation with the imaging lens 308. The dichroic mirror 307 transmits the excitation light and the fluorescent light and reflects the stimulus light. The imaging lens 308 focuses the fluorescent light to form an intermediate image. The objective 310 focuses the excitation light on the surface of the specimen. The confocal lens 312 focuses the fluorescent light on the confocal stop 313. The confocal stop 313 has a pinhole at a position optically conjugate with the position of the front focal point (on the specimen Sb) of the objective 310. The barrier filter 314 blocks the excitation light. The photodetector 315 detects the fluorescent light transmitted through the barrier filter 314.

The scan unit 305 includes a first galvanometer mirror 305a, which moves the focus position of the excitation light on the specimen surface along the X direction perpendicular to the optical axis to scan the specimen Sb along the X direction, and a second galvanometer mirror 305b, which moves the focus position of the excitation light on the specimen surface along the Y direction perpendicular to the X direction and the optical axis to scan the specimen Sb along the Y direction. The first and second galvanometer mirrors 305a, 305b are arranged in such a way that a pupil conjugate plane optically conjugate with the pupil plane 310P of the objective 310 is formed at approximately the center between them.

The stimulus light unit includes a laser light source 316, a shutter 317, a mirror 318, a beam diameter changing optical system including lenses 319 and 320, a field stop 321, a condenser lens 322, a plane parallel plate 323, the scan unit 324, a pupil projection lens 325, the dichroic mirror 307, the imaging lens 308, the mirror 309, and the objective 310. The laser light source 316 emits stimulus light (laser light) for stimulating the specimen Sb. The beam diameter changing optical system can change the beam diameter of the stimulus light. The field stop 321 is located in a plane optically conjugate with the front focal plane (on the specimen surface) of the objective 310 and has a variable aperture diameter. The condenser lens 322 focuses the stimulus light on the pupil conjugate plane 310 conjugate with the pupil plane 310P of the objective 310. The plane parallel plate 323 can shift the stimulus light in a direction perpendicular to the optical axis. The scan unit 324 scans the specimen Sb by moving the position of irradiation with the stimulus light on the specimen Sb. The pupil projection lens 325 projects the pupil of the objective 310 onto the scan unit 305 in cooperation with the imaging lens 308. The objective 310 delivers the stimulus light to the specimen Sb. The dichroic mirror 307, the imaging lens 308, the mirror 309, and the objective 310 are common components of the stimulus light unit and the observation unit.

The scan unit 324 includes a first galvanometer mirror 324a, which shifts the irradiation position of the stimulus light on the specimen surface along the X direction perpendicular to the optical axis to scan the specimen Sb along the X direction, and a second galvanometer mirror 324b, which moves the focus position of the stimulus light on the specimen surface along the Y direction perpendicular to the X direction and the optical axis to scan the specimen Sb along the Y direction. The first and second galvanometer mirrors 324a, 324b are arranged in such a way that a pupil conjugate plane optically conjugate with the pupil plane 310P of the objective 310 is formed at approximately the center between them. The first and second galvanometer mirrors 324a and 324b rotate, for example, about the Y axis and the X axis respectively.

The plane parallel plate 323 serves as a shift unit. The stimulus light is transmitted through the plane parallel plate 323, and its incidence surface on which the stimulus light incident can be inclined at a desired angle relative to the X-Y plane perpendicular to the optical axis. In other words, the plane parallel plate 323 is adapted to be rotatable about both the X and Y axes.

The control unit 326 is connected with a laser light source 302, the scan unit 305, the photodetector 315, the laser light source 316, the plane parallel plate 323, and the scan unit 324. The control unit 326 controls the wavelength and/or intensity of light emitted from the laser light sources 302 and 316, supplies scan signals to the scan units 305 and 324, controls the rotation of the plane parallel plate 323, and receives electrical signals from the photodetector 315.

The overall operation of the laser microscope apparatus 301 will be described.

Excitation light emitted from the laser light source 302 as parallel light is incident on the dichroic mirror 304 after passing through the shutter 303, reflected by the dichroic mirror 304, and incident on the scan unit 305. The scan unit 305 is controlled by a scan signal from the control unit 326 to deflect the excitation light by the galvanometer mirrors 305a and 305b respectively in the X direction and Y direction perpendicular to the optical axis. The excitation light departing from the scan unit 305 is incident on the pupil projection lens 306 and converged by the pupil projection lens 306. Then, the excitation light is transmitted through the dichroic mirror 307 as convergent light or divergent light and incident on the imaging lens 308 as divergent light.

The excitation light is changed into parallel light again by the imaging lens 308, reflected by the mirror 309, incident on the objective 310, and focused on the specimen Sb by the objective 310. In the portion of the specimen Sb on which the excitation light is focused, the fluorescent material contained in the specimen Sb is excited to emit fluorescent light. The focus position on the specimen surface can be shifted in the X and Y directions as desired by controlling the amount of deflection in the X and Y directions in the scan unit 305.

Fluorescent light emitted from the specimen Sb is changed into parallel light by the objective 310 and travels along the same path as the excitation light but in the reverse direction. Thus, the fluorescent light is reflected by or transmitted through the mirror 309, the imaging lens 308, the dichroic mirror 307, the pupil projection lens 306, and the scan unit 305, and incident on the dichroic mirror 304.

The fluorescent light incident on the dichroic mirror 304 is transmitted through the dichroic mirror 304 and focused on the confocal stop 313 arranged in a plane conjugate with the specimen surface (i.e. the front focal plane of the objective 310) by the confocal lens 312. The fluorescent light emergent from the focus position passes through the pinhole of the confocal stop 313 and then is transmitted through the barrier filter 314 and detected by the photodetector 315.

The photodetector 315 detects fluorescent light or converts it into an electrical signal and sends the electrical signal to the control unit 326. The control unit 326 generates an image of the specimen Sb from the electrical signal sent from the photodetector 315 and the scan signal supplied to the scan unit 305.

On the other hand, the stimulus light emitted as parallel light from the laser light source 316 passes through the shutter 317, and is incident on and reflected by the mirror 318 and then incident on the beam diameter changing optical system including the lenses 319 and 320. The beam diameter of the stimulus light is adjusted by the beam diameter changing optical system, and the stimulus light is incident on the field stop 321 as parallel light.

The field stop 321 is a variable stop, which is arranged in a plane optically conjugate with the specimen surface. Therefore, it is possible to adjust the beam diameter of the stimulus light on the specimen surface to thereby control the illumination area with the stimulus light on the specimen Sb by adjusting the beam diameter of the stimulus light passing through the field stop 321 by changing the aperture diameter of the field stop 321.

The intensity of the stimulus has a Gaussian distribution, and the field stop 321 blocks the peripheral portion of the Gaussian distribution (i.e. the peripheral portion of the stimulus light beam) and transmits the central portion of the Gaussian distribution (i.e. the central portion of the stimulus light beam) in which the intensity is relatively uniform. Consequently, the unevenness in the intensity distribution of the stimulus light with which the specimen Sb is illuminated is reduced, so that the specimen Sb can be illuminated at relatively uniform intensity.

The stimulus light transmitted through the field stop 321 is converted into convergent light by the condenser lens 322 and incident on and transmitted through the plane parallel plate 323 as convergent light. The stimulus light transmitted through the plane parallel plate 323 is translated (or parallel shifted) by the plane parallel plate 323 in a direction perpendicular to the optical axis by an amount determined by the refractive index of the plane parallel plate 323 and the angle of incidence on the plane parallel plate 323, and incident on the scan unit 324 as convergent light. The amount of translation (which will be hereinafter referred to as the shift amount) of the stimulus light relative to the optical axis through the plane parallel plate 323 is controlled by the control unit 326, which drives the plane parallel plate 323.

The scan unit 324 controlled by the scan signal supplied from the control unit 326 deflects the stimulus light in the X and Y directions perpendicular to the optical axis by the galvanometer mirrors 324a and 324b respectively. The stimulus light deflected by the scan unit 324 is incident on the pupil projection lens 325 as divergent light, converted into parallel light by the pupil projection lens 325, and then incident on the dichroic mirror 307. The stimulus light incident on the dichroic mirror 307 is reflected by the dichroic mirror 307 and then focused on the pupil plane 310P of the objective 310 by the imaging lens 308 via the mirror 309.

The stimulus light focused on the pupil plane 310P is converted into parallel light again by the objective 310 and is illuminated on the specimen Sb. The irradiation position of the stimulus light on the specimen surface can be shifted in the X and Y directions as desired by controlling the amount of deflection in the X and Y directions in the scan unit 324.

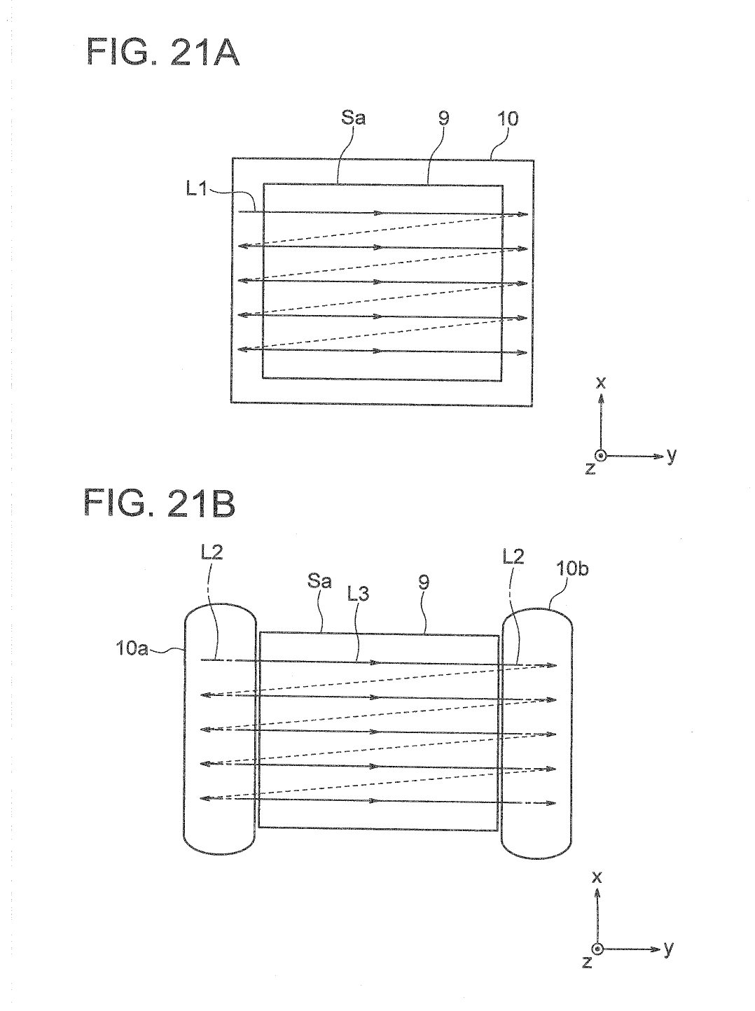

Next, the use of the stimulus light in bleaching reduction illumination will be described. FIG. 21A is a diagram showing the sample Sa seen along the Z direction (the direction in which the stimulus light travels). The scan unit 305 of the observation unit scans the sample Sa with illumination light L1 horizontally from left to right in FIG. 21A in the X-Y plane perpendicular to the optical axis (Z axis) as indicated by solid lines in FIG. 21A. The illumination light L1 returns from a right end position to a left position in FIG. 21A along the path indicated by a broken line. In the period indicated by the broken line, the illumination light L1 is off. Switching between on and off of the illumination light L1 can be done by blocking the path of the illumination light L1 by the shutter 303 or turning on/off the laser light source 302. During the scanning with the illumination light L1, the galvanometer mirrors 324a and 324b of the scan unit 324 in the stimulus light unit are rotationally driven in cooperation with each other, thereby moving the stimulus light emitted from the laser light source 316 is moved in a rectangular path running along the outer periphery of the observed region 9.

Thus, a bleaching reduction illumination region 10 around the sample Sa shown in FIG. 21A can be illuminated with the stimulus light. In this process, the sample Sa may also be illuminated with the stimulus light. Consequently, the laser light source 316 illuminates at least the bleaching reduction illumination region 10 around the observed region 9 in which the sample Sa is present. Therefore, bleaching can be reduced as described in the description of the first embodiment.

In a mode of this embodiment, a chemical compound that can chemically produces active oxygen by, for example, irradiation with light of a specific wavelength may be applied on a slide glass on which the sample Sa is placed or added to the sample Sa as a content. When light of the specific wavelength is illuminated to the region outside the observed region, the chemical compound receives the light of the specific wavelength to produce active oxygen. This can cause oxygen to be consumed. Consequently, bleaching can be reduced. In connection with this, it is preferred that the wavelength of the illumination light (stimulus light) L1 be shorter.

FIG. 21B shows another mode of this embodiment. FIG. 21B shows a way of scanning the sample Sa with illumination light emitted from the laser light source 302 of the observation unit in imaging using the laser scanning microscope. The sample Sa is illuminated with illumination light L3. Fading reduction illumination regions 10a, 10b are illuminated with illumination light L2 having characteristics optically different from the illumination light L3. The bleaching reduction illumination regions 10a, 10b are regions corresponding to blanking intervals which are not illuminated with illumination light in conventional apparatuses. In this mode, the bleaching reduction illumination regions 10a, 10b corresponding to blanking intervals are intentionally illuminated with illumination light L2.

It is desirable that the irradiance of the illumination light L2 be higher than the irradiance of the illumination light L3. The irradiance of the illumination light can be controlled by using an AOM (acousto-optic modulator), controlling the output power of the laser light source, or providing a filter having a predetermined transmittance such as an ND filter in the optical path. In this way, it is possible to produce active oxygen in the bleaching reduction illumination regions 10a, 10b and to consume oxygen. In consequence, bleaching can be reduced.

It is preferred that the illumination light L2 have a specific wavelength, for example, shorter than the wavelength of the illumination light L3. The wavelength of the illumination light can be controlled by using an AOM, selectively using one of a plurality of LEDs that emit light of different wavelengths as the light source, or using a light source that emits light of continuous wavelength and providing a wavelength selective filter in the optical path.

As described above, in the case, for example, where the specific wavelength of light by which the sample Sa is excited is the wavelength of red (R) light, it is preferred for the purpose of bleaching reduction that the illumination light L2 be ultraviolet (UV) light, blue (B) light, and green (G) light, where the shorter the wavelength (i.e. the former among the above three kinds of light) is, the more preferable it is.

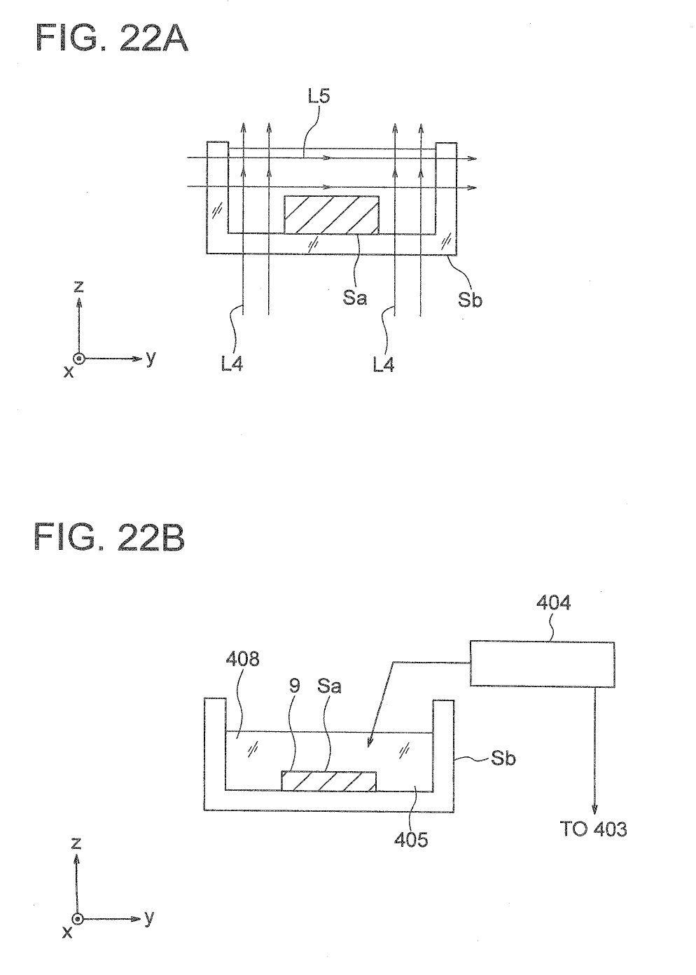

The bleaching reduction illumination may be applied to a three-dimensional space around the sample Sa. FIG. 22A shows a case in which light L4 and light L5 perpendicular to light L4 are applied to the sample Sa for bleaching reduction illumination. Thus, bleaching reduction illumination can be applied in such away as to three-dimensionally cover the space around the sample Sa.

In the case shown in FIG. 22A, the sample Sa may be illuminated by light L4 and light L5.

### Eleventh Embodiment

Next, a microscopy observation method according to an eleventh embodiment will be described.

In this embodiment, it is preferred that the oxygen concentration reduction step include an oxygen inflow reduction step for reducing inflow of oxygen into the observed region.

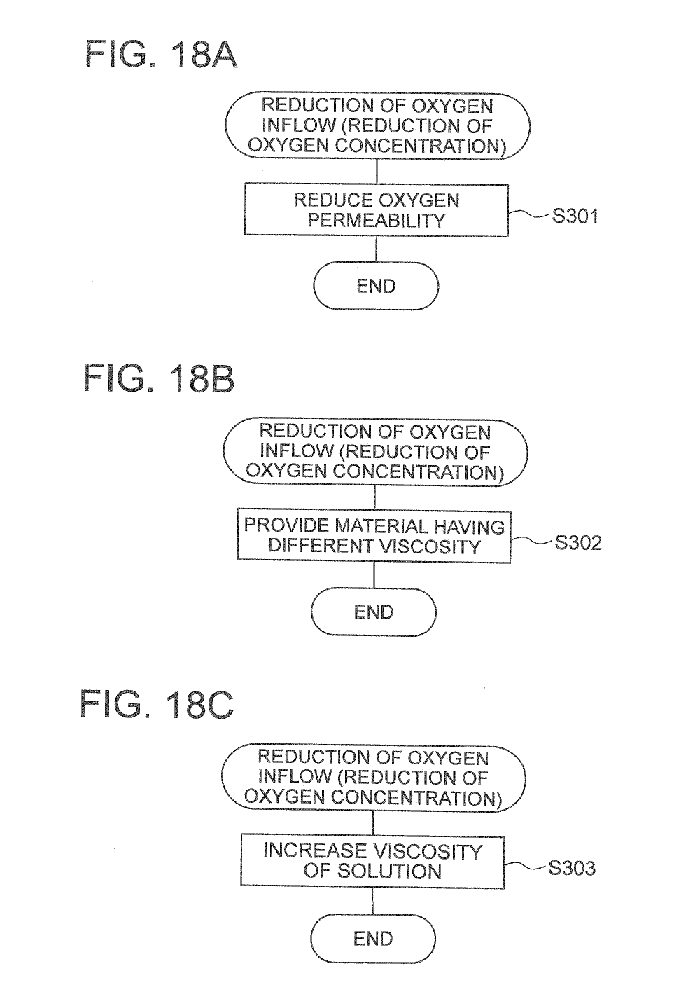

For example, as shown in FIG. 18A, it is preferred that the oxygen inflow reduction step include step S301 in which the oxygen permeability in the region outside the observed region is made lower than the oxygen permeability in the environment around the sample Sa.

More specifically, a medium having oxygen permeability lower than the oxygen permeability in the vicinity of the sample Sa is provided around the sample Sa. This medium may be an aluminum foil. The oxygen permeability of the aluminum foil is lower than 0.006 (cc/m²·day).

It is more preferred that the oxygen permeability in the region surrounding the observed region be made low. This can further improve the efficiency of bleaching reduction.

As shown in FIG. 18B, it is preferred that the oxygen inflow reduction step include step S302 in which the viscosity in the region outside observed region be made higher than the viscosity in the environment around the sample Sa.

It is more preferred that the oxygen inflow reduction step include step S303 in which the viscosity in the region surrounding the observed region is made higher than the viscosity in the environment around the sample Sa. This can further improve the efficiency of bleaching reduction.

FIG. 22B shows a portion around the sample in the apparatus according to this embodiment. The sample Sa is placed in a specimen Sb including a glass bottom dish. The sample Sa is immersed in buffer solution 408. The apparatus has a high viscosity medium supply unit 404, which supplies a high viscosity medium 405 to the specimen Sb in response to a command signal from the control unit 403. This can reduce the quantity and the flow speed of oxygen flowing into the sample Sa from outside. In consequence, bleaching of the sample Sa can be reduced.

It is preferred that the oxygen concentration reduction step include the step of making the viscosity of the material around the sample Sa higher than a specific viscosity. This enables further reduction of bleaching.

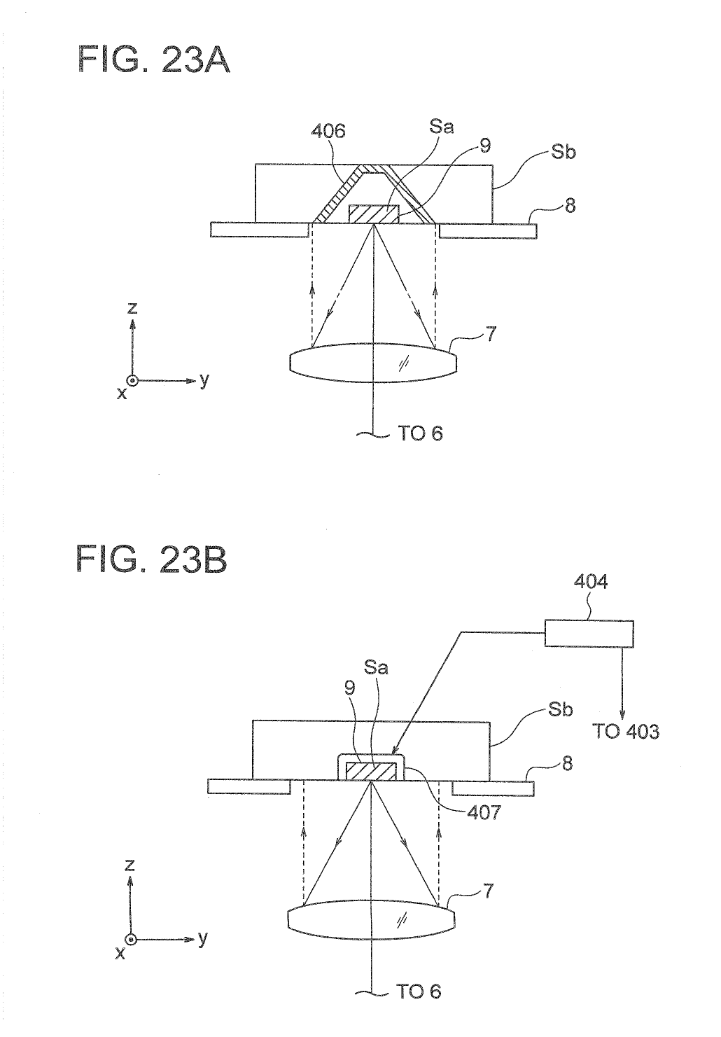

FIG. 23A shows a case in which a physical wall 406 that surrounds the sample Sa is provided. The physical wall 406 may be made of a material having a high viscosity.

FIG. 23B shows a case in which a layer 407 of castor oil is formed in such a way as to cover the sample Sa. It is preferred that this layer have a thickness of 20 μm or larger. This arrangement is employed in the case where typical phosphate buffered saline (PBS) is used as the buffer solution of the dish specimen.

### Twelfth Embodiment

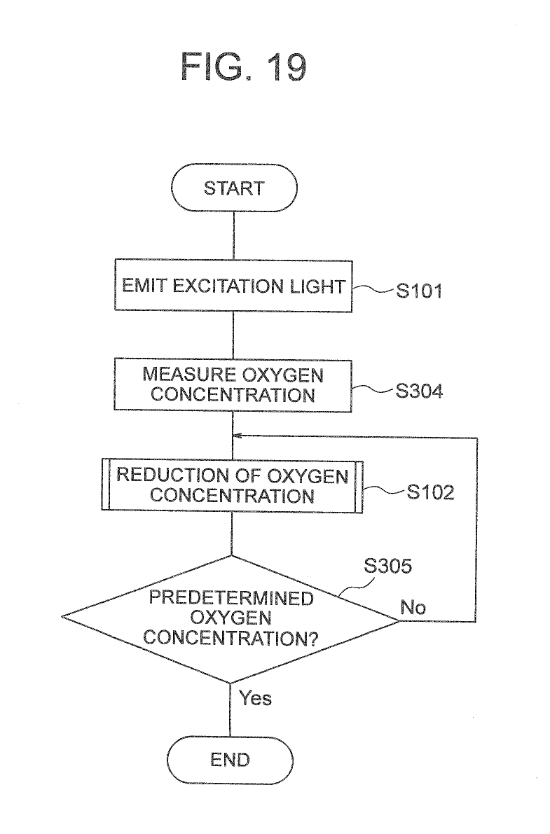

In the twelfth embodiment, as shown in FIG. 19, the oxygen concentration in the sample Sa is measured in the oxygen concentration measuring step S304. The oxygen concentration in the sample Sa is reduced based on the oxygen concentration measured in the oxygen concentration measuring step S304. The reduction of oxygen concentration can be carried out by one of the methods according to above-described embodiments. In step S305, it is determined whether or not the oxygen concentration in the sample Sa is a predetermined concentration. If the determination made in step S305 is affirmative (Yes), the process is ended. If the determination made in step S305 is negative (No), the process returns to step S102, where the process of reducing the oxygen concentration is executed.

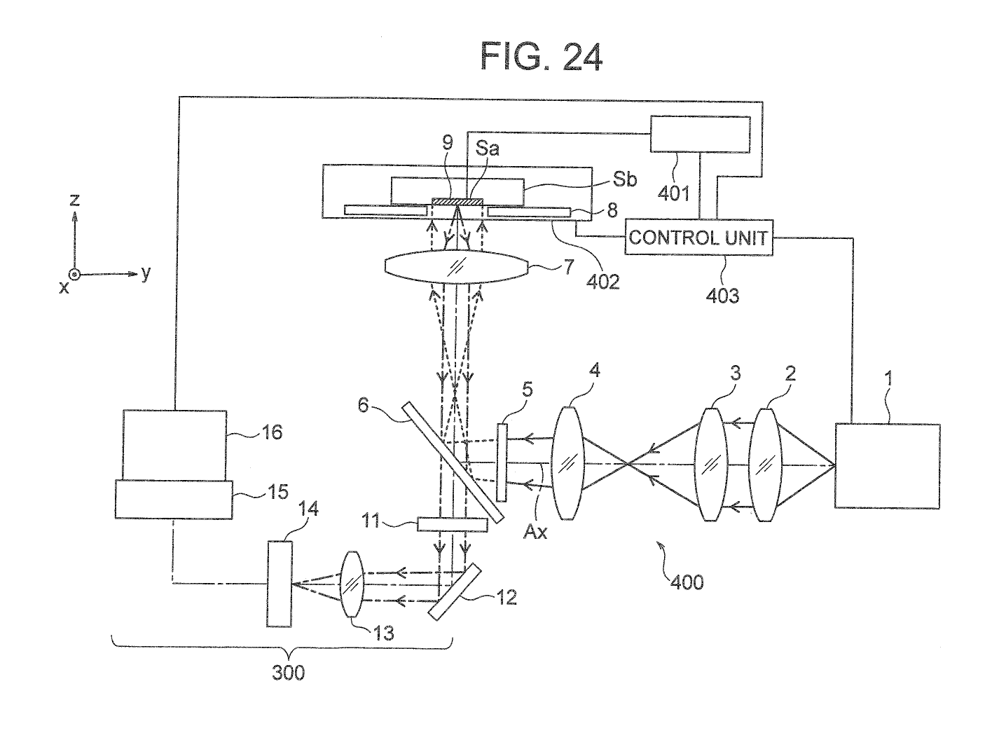

FIG. 24 shows the configuration of an apparatus used to carry out this embodiment. The components same as those in the apparatus shown in FIG. 1 are denoted by the same reference signs and will not be described redundantly. The apparatus has a oxygen concentration measurement unit 401, which measures the oxygen concentration in the sample Sa.

In the oxygen concentration measurement unit 401, an oxygen concentration measuring system according to one of the following methods may be employed.

(1) measuring the oxygen concentration directly using a dissolved oxygen sensor using electrodes;

(2) measuring the oxygen concentration by observing fluorescent light;

(3) measuring the oxygen concentration by fluorescence observation using an agent having fluorescent characteristics that changes depending on the change in the oxygen concentration, specifically, measuring the oxygen concentration by measuring a change in the duration of fluorescence and/or the intensity of fluorescent light, which depends on the oxygen concentration.

Here, the dissolved oxygen sensor using electrodes will be described. An oxygen electrode can be used as means for measuring dissolved oxygen. Two metal electrodes or a working electrode and a counter electrode are provided in the oxygen electrode, and the interior of the oxygen electrode is filled with electrolyte. Then end of the electrode is covered with a Teflon (registered trademark) film that has the property of conducting oxygen while being impermeable to ions (diaphragm electrode).

In the electrode, oxidation-reduction reaction occurs with oxygen having passed through the Teflon (registered trade mark), resulting in electrical current proportional to the quantity of oxygen thus passing through the film. The quantity of oxygen passing through the Teflon (registered trademark) film is proportional to the dissolved oxygen concentration in the target solution. Therefore, the dissolved oxygen concentration can be measured by measuring the electrical current.

There are two types of diaphragm electrode, which include a polarographic electrode, to which a constant voltage (in the range between 0.5 and 0.8 volt) is externally applied, and a galvanic cell electrode, to which no voltage is applied externally. In the case of the diaphragm electrode, these two types do not have a major difference in their structure, but the combination of metals used as the working electrode and the counter electrode and the electrolyte used are different between them. The oxygen concentration measurement unit 401 may use the above-described sensor.

The control unit 403 decreases the temperature of the specimen Sb by, for example, controlling a cooling unit 402 on the basis of the oxygen concentration measured by the oxygen concentration measuring unit 401. Microscopy observation is performed typically at a temperature about 37° C. in the case of animal specimens and 27° C. in the case of botanical specimens. In this apparatus, when the specimen is observed, the temperature of the specimen is kept lower than the aforementioned temperatures, within a temperature range allowing vital activity. A reduction in the temperature leads to a reduction in the diffusion coefficient (m²/s) of oxygen. Consequently, generation of oxygen can be reduced, so that bleaching can be reduced.

In the case of time-lapse imaging with the laser microscope, the oxygen concentration may be reduced only at the time of imaging.

The embodiments can be modified in various ways without departing from their essence.

As described above, the present invention can be applied to an illumination apparatus and a microscope apparatus and a microscopy observation method using the same to increase the total energy that can be applied before bleaching occurs and to reduce bleaching.

The present invention is advantageous in providing an illumination apparatus and a microscope apparatus and a microscopy observation method using the same with which the total energy that can be applied before bleaching occurs can be increased and bleaching can be reduced.

What is claimed is:

1. An illumination apparatus used for fluorescence observation of a sample containing a fluorescent material by a microscope apparatus, comprising an excitation light emission unit that emits excitation light for exciting the fluorescent material contained in the sample, wherein the excitation light emission unit illuminates at least a bleaching reduction illumination region around an observed region in which the sample is present.

2. An illumination apparatus according to claim 1, wherein an area illuminated by the excitation light emission unit satisfies the following conditions (1) and (2):
1.3<φexc/φobj (1), and
0.002 mm<φexc−φobj (2),
where φobj is the largest diameter of a region observed by the objective that the microscope apparatus has on the surface of the sample, and φexc is the largest diameter of the excitation light on the surface of the sample emitted by the illumination light source as the excitation light emission unit.

3. An illumination apparatus according to claim 1, wherein an illumination area of the excitation light emission unit includes at least the observed region in which the sample is observed and the bleaching reduction illumination region outside around the observed region, and the irradiance of excitation light with which the bleaching reduction illumination region is illuminated is different from the irradiance of excitation light with which the observed region is illuminated.

4. An illumination apparatus according to claim 3, wherein the irradiance of excitation light with which the bleaching reduction illumination region is illuminated is higher than the irradiance of excitation light with which the observed region is illuminated.

5. An illumination apparatus according to claim 2, further comprising an illumination optical system, wherein a part of the excitation light emitted from the excitation light emission unit which illuminating on the observed region is focused on the surface of the sample in the observed region, and illumination optical system focuses the excitation light illuminating the bleaching reduction illumination region at a position different from the surface of the sample with respect to the direction along the optical axis.

6. An illumination apparatus according to claim 3, wherein a first excitation light emission unit that illuminates the bleaching reduction illumination region with the excitation light has an optical member having a slit arranged in the optical path at a position of a field stop conjugate with the sample.

7. An illumination apparatus according to claim 6, wherein the slit of the optical member has an annular shape that is rotationally symmetrical about the optical axis.

8. An illumination apparatus according to claim 7, wherein the optical member is provided with an ND filter in a region closer to the optical axis than the slit, the observed region being illuminated with excitation light transmitted through the ND filter, and the bleaching reduction illumination region being illuminated with excitation light passing through the slit.

9. An illumination apparatus according to claim 1, wherein an illumination area of the excitation light emission unit includes at least the observed region in which the sample is observed and the bleaching reduction illumination region around the outer periphery of the observed region, and the wavelength of excitation light with which the bleaching reduction illumination region is illuminated is different from the wavelength of excitation light with which the observed region is illuminated.

10. An illumination apparatus according to claim 9, wherein the wavelength of excitation light with which the bleaching reduction illumination region is illuminated is shorter than the wavelength of excitation light with which the observed region is illuminated.

11. An illumination apparatus according to claim 9, further comprising an illumination optical system, wherein a part of the excitation light emitted from the excitation light emission unit which illuminating on the observed region is focused on the surface of the sample in the observed region, and the illumination optical system focuses the excitation light illuminating the bleaching reduction illumination region at a position different from the surface of the sample with respect to the direction along the optical axis.

12. An illumination apparatus according to claim 9, wherein a first excitation light emission unit illuminates the bleaching reduction illumination region with the excitation light has an optical member having a slit arranged in the optical path at a position of a field stop conjugate with the sample.

13. An illumination apparatus according to claim 12, wherein the slit of the optical member has an annular shape that is rotationally symmetrical about the optical axis.

14. An illumination apparatus according to claim 9, further comprising an optical member having a slit arranged in the optical path at a position of a field stop conjugate with the sample, the optical member being provided with a wavelength selection element in a region closer to the optical axis than the slit, the observed region being illuminated with excitation light transmitted through the wavelength selection element, and the bleaching reduction illumination region being illuminated with excitation light passing through the slit.

15. A microscope apparatus for fluorescence observation of a sample, comprising:
a stage by which a sample is held;
an illumination apparatus according to claim 1 that emits excitation light with which the sample is illuminated; and
an objective arranged to be opposed to the sample.

16. A microscopy observation method for fluorescence observation of a sample including an object to be observed containing a fluorescent material using a microscope apparatus, comprising:
an excitation light emission step of emitting excitation light for exciting the fluorescent material contained in the sample; and
an oxygen concentration reduction step of reducing the oxygen concentration at least in an observed region in which the sample is present.

17. A microscopy observation method according to claim 16, wherein the oxygen concentration reduction step comprises an oxygen consumption step of consuming oxygen in a region outside the observed region.

18. A microscopy observation method according to claim 17, wherein the oxygen consumption step comprises:
a bleaching reduction illumination step of illuminating at least a bleaching reduction illumination region around the observed region in which the sample is present; and
an excitation light irradiance control step of controlling the irradiance of excitation light with which the bleaching reduction illumination region is illuminated in the bleaching reduction illumination step.

19. A microscopy observation method according to claim 18, wherein in the bleaching reduction illumination step, the irradiance of excitation light with which the bleaching reduction illumination region is illuminated is higher than the irradiance of excitation light with which the observed region is illuminated.

20. A microscopy observation method according to claim 17, wherein the oxygen consumption step comprises:
a bleaching reduction illumination step of illuminating at least a bleaching reduction illumination region around the observed region in which the sample is present; and
an excitation light wavelength control step of controlling the wavelength of excitation light with which the bleaching reduction illumination region is illuminated in the bleaching reduction illumination step.

21. A microscopy observation method according to claim 20, wherein in the bleaching reduction illumination step, the bleaching reduction control region is illuminated with excitation light having a wavelength shorter than a wavelength of red light.

22. A microscopy observation method according to claim 16, wherein the oxygen concentration reduction step comprises an oxygen inflow reduction step of reducing inflow of oxygen into the observed region.

23. A microscopy observation method according to claim 22, wherein the oxygen inflow reduction step comprises a step of making the oxygen permeability in a region outside the observed region lower than the oxygen permeability in an environment around the sample.

24. A microscopy observation method according to claim 22, wherein the oxygen inflow reduction step comprises a step of making the oxygen permeability in a region surrounding the observed region lower than the oxygen permeability in an environment around the sample.

25. A microscopy observation method according to claim 23, wherein the oxygen inflow reduction step comprises a step of making the viscosity in the region outside the observed region higher than the viscosity in the environment around the sample.

26. A microscopy observation method according to claim 25, wherein the oxygen inflow reduction step comprises a step of making the viscosity in a region surrounding the observed region higher than the viscosity in the environment around the sample.

27. A microscopy observation method according to claim 16, wherein the oxygen concentration reduction step comprises a step of making the viscosity of a material in a region around the sample higher than a viscosity of a buffer solution in which the sample is immersed.

28. A microscopy observation method according to claim 16, further comprising:
an oxygen concentration measurement step of measuring the oxygen concentration in the sample; and
an oxygen concentration reduction step of controlling the oxygen concentration in the sample based on the oxygen concentration measured in the oxygen concentration measurement step.
